(19) United States
(12) Patent Application Publication
(10) Pub. No.: US 2007/0040763 A1
(43) Pub. Date: Feb. 22, 2007

(54) Image display system

(75) Inventor: Szu-Hao Lyu, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/234,929

(22) Filed: Sep. 26, 2005

(30) Foreign Application Priority Data
Aug. 19, 2005 (TW) 094128366

(51) Int. Cl. G09G 5/00

(52) U.S. Cl. 345/1.3

(57) ABSTRACT

An image display system for simultaneously displaying an original image and a processed image of the original image is provided. The image display system includes a display screen, a first memory unit, a second memory unit and a control unit. In response to some specified commands, the original image and the processed image may be simultaneously magnified and moved and some specific pixel data thereof are simultaneously shown. Since the user is able to view the difference between the original image and the processed image in real time, the image display system of the present invention is user-friendly and efficient.

### FIELD OF THE INVENTION

The present invention relates to an image display system, and more particularly to an image display system capable of simultaneously displaying the original image and the processed image.

### BACKGROUND OF THE INVENTION

Currently, many imaging tools were widely used for processing images such as image sharpening, brightness adjustment and color space conversion. By adjusting related parameters of the image tools, desired image display performance is obtainable.

In a conventional imaging tool, an original image file is opened and then an image processing command is executed to process the original image file, thereby directly displaying the processed image on the screen.

According to the conventional image display method, either the original image or the processed image is shown on the screen at a time. In other word, the user fails to realize the difference between the original image and the processed image on the same display screen. Consequently, the influence of the image processing command on the original image is uncertain to the user.

For a purpose of displaying the original image and the processed image on the same display screen in real time, a cut and paste method is required to simultaneously display these images.

An approach for simultaneously displaying the original image and the processed image on the same display screen is described in Taiwanese Patent No. 591935, entitled “A color processing and previewing method of an input image frame”. Referring to FIG. 1, the displayed images generated according to the method of Taiwanese Patent No. 591935 is schematically illustrated. Firstly, an original image 100 is displayed. Then, a preview block 100A is generated and an image processing command is executed on the image within the preview block 100A. Under this circumstance, the user is able to realize the processed image in the preview block 100A. This approach, however, has some drawbacks. For example, since only a portion of the original image is shown in the preview block 100A, the user fails to realize the difference between the original image and the processed image on the same image frame.

Another approach for simultaneously displaying the original image and the processed image on the same display screen is disclosed in Japanese Laid-Open patent application No. 2004-120406. Referring to FIG. 2, the displayed images generated according to the method of Japanese Laid-Open patent application No. 2004-120406 is schematically illustrated. As shown in FIG. 2, the screen is divided into two parts. The original image 200 is shown on the first part of the screen. Whereas, the processed image 200A is shown on the second part of the screen. Although the user can simultaneously view the original image and the processed image on the screen, the processed image shown on the screen fails to be further processed. In order words, if the processed image 200A is to be further processed, the current displayed image frame should be closed. After the processed image 200A is re-opened for further processing and stored as a file, a frame dividing function is employed to simultaneously display the original image and the further processed image.

Accordingly, the above-described methods are not perfect designs and still have many disadvantages to be solved. In views of the above-described disadvantages resulted from the conventional methods, the applicant keeps on carving unflaggingly to develop an image display system according to the present invention through wholehearted experience and research.

### SUMMARY OF THE INVENTION

It is an object of the present invention to provide an image display system for simultaneously displaying, magnifying and dragging the original image and the processed image, thereby identifying the difference between the original image and the processed image and enhancing performance of the image tools.

In accordance with a first aspect of the present invention, there is provided an image display system for simultaneously displaying an original image and a processed image of the original image on a display screen. The image display system comprises a monitor including the display screen, a first memory unit, a second memory unit and a control unit. The display screen is divided into a first display portion and a second display portion for displaying the original image and the processed image, respectively. The first memory unit comprises a first memory portion and a second memory portion for storing therein all image data of the original image and the processed image, respectively. The second memory unit comprises a first memory portion and a second memory portion for storing the image data of the original image to be displayed on the screen and the image data of the processed image to be displayed on the screen. The control unit includes a display control module for controlling the original image displayed on the first display portion and the processed image on the second display portion according to execution of user's input commands.

In an embodiment, the user's input commands are commands associated with an image magnifying operation and an image dragging operation.

In an embodiment, the pixel brightness data of the original image and the processed image are displayed on the display screen in response to the user's input command.

Preferably, the display control module is a software program.

In accordance with a first aspect of the present invention, there is provided an image display method for simultaneously displaying an original image and a processed image of the original image on a display screen. Firstly, the display screen is divided into a first display portion and a second display portion. Then, part of the original image are displayed on the first display portion. After the original image is processed, the processed image is obtained. Then, part of the processed image are displayed on the second display portion. Afterward, the original image on the first display portion and the processed image on the second display portion are controlled according to execution of user's input commands.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the original image and the image processed according to the method of Taiwanese Patent No. 591935;

FIG. 2 schematically illustrates the original image and the image processed according to the method of Japanese Laid-Open patent application No. 2004-120406;

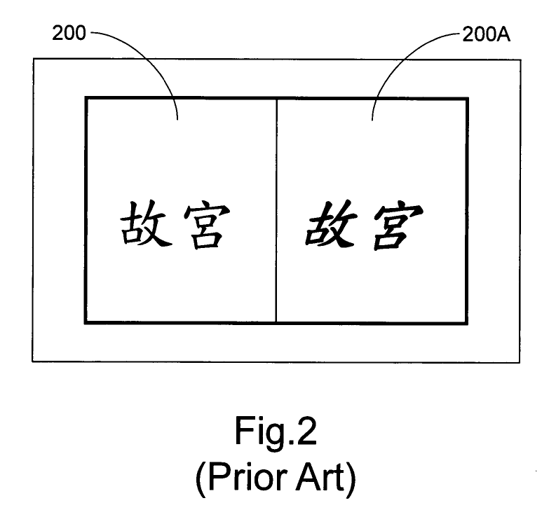

FIG. 3 schematically illustrates a function block diagram of an image display system according to a preferred embodiment of the present invention;

FIG. 4 schematically illustrates the image data stored in the first memory unit;

FIGS. 5A and 5B schematically illustrate the image data stored in the second memory unit;

FIG. 6 schematically illustrates a user operation interface for operating the image display system of the present invention, in which the display screen is divide into left and right portions;

FIG. 7 schematically illustrates a user operation interface for operating the image display system of the present invention, in which parts of the original image are displayed on the left display portion of the display screen;

FIG. 8 schematically illustrates a user operation interface for operating the image display system of the present invention, in which the original image is processed in response to a selected image processing command;

FIG. 9 schematically illustrates a user operation interface for operating the image display system of the present invention, in which parts of the original image and corresponding processed image are displayed on the left and right display portions of the display screen, respectively;

FIG. 10 schematically illustrates the generated image according to execution of a dragging commands on the image of FIG. 9;

FIG. 11 schematically illustrates a user operation interface for operating the image display system of the present invention, in which a magnification selective menu is shown; and

FIG. 12 schematically illustrates a user operation interface for operating the image display system of the present invention, in which the pixel data of the original image and the processed image are shown.

### DETAILED DESCRIPTION OF THE PREFERRED EMBODIMENT

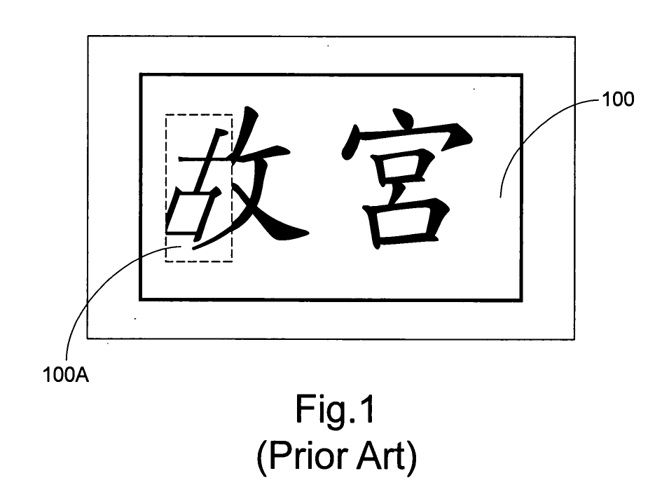

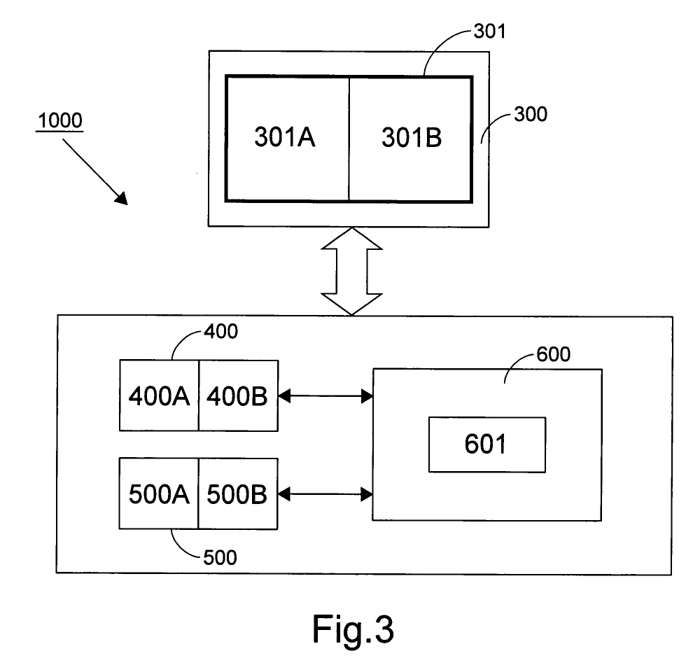

Referring to FIG. 3, a functional block diagram of an image display system according to a preferred embodiment of the present invention is shown. The image display system 1000 of FIG. 1 comprises a monitor 300, a first memory unit 400, a second memory unit 500 and a control unit 600. The monitor 300 includes a display screen 301, which is divided into a first display portion 301A and a second display portion 301B. The first memory unit 400 comprises a first memory portion 400A and a second memory portion 400B. The second memory unit 500 comprises a first memory portion 500A and a second memory portion 500B. The control unit 600 includes a display control module 601.

The first display portion 301A of the display screen 301 of the monitor 300 is used to display the original image. Whereas, the second display portion 301B of the display screen 301 displays the processed image after the original image is processed by image sharpening/blurring operation, for example. The display control module 601 of the control unit 600 is a software program for controlling operation of the present image display system.

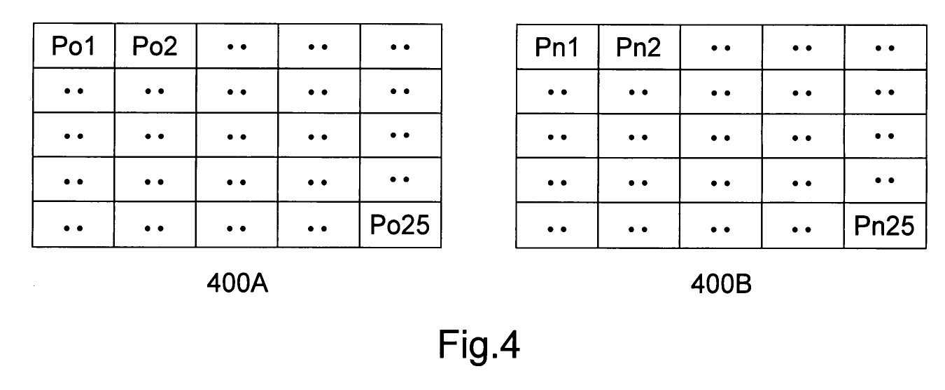

All image data of the original image and the processed image are stored in the first memory unit 400. As shown in FIG. 4, the image data Po1˜Po25 of the original image are stored in the first memory portion 400A of the first memory unit 400. Whereas, the image data Pn1˜Pn25 of the processed image are stored in the second memory portion 400B of the first memory unit 400.

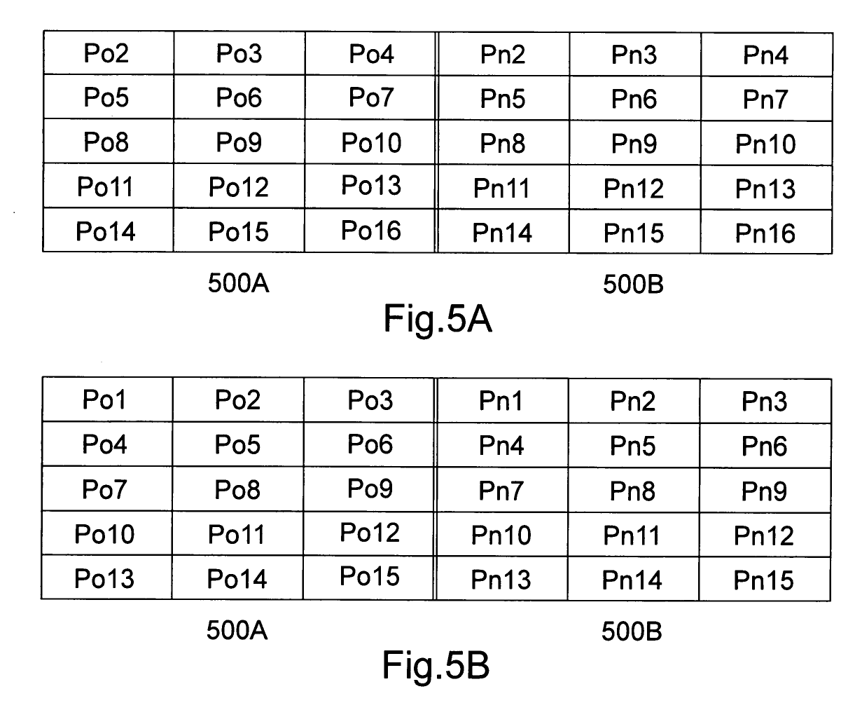

The original image and the processed image shown on the display screen 301 are stored in the second memory unit 500. As shown in FIG. 5A, the image data Po2˜Po16 of the original image, which are displayed on the first display portion 301A of the display screen 301, are stored in the first memory portion 500A of the second memory unit 500. Whereas, the image data Pn2˜Pn16 of the processed image, which are displayed on the second display portion 301B of the display screen 301, are stored in the second memory portion 500B of the second memory unit 500. Please refer to FIG. 5B, which illustrates the original image and the processed image shown on the display screen 301 in response to execution of a dragging command. Under this circumstance, the image data Po1˜Po15 of the original image, which are displayed on the first display portion 301A of the display screen 301, are stored in the first memory portion 500A of the second memory unit 500. Whereas, the image data Pn1˜Pn15 of the processed image, which are displayed on the second display portion 301B of the display screen 301, are stored in the second memory portion 500B of the second memory unit 500.

A user operation interface for operating the image display system of the present invention will be illustrated as follows.

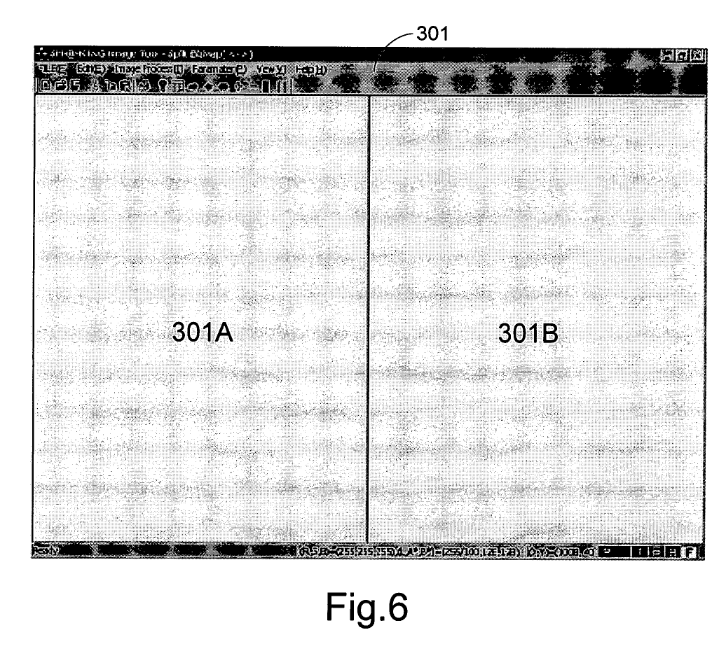

Firstly, as shown in FIG. 6, the display screen 301 is divided into the first display portion 301A and the second display portion 301B.

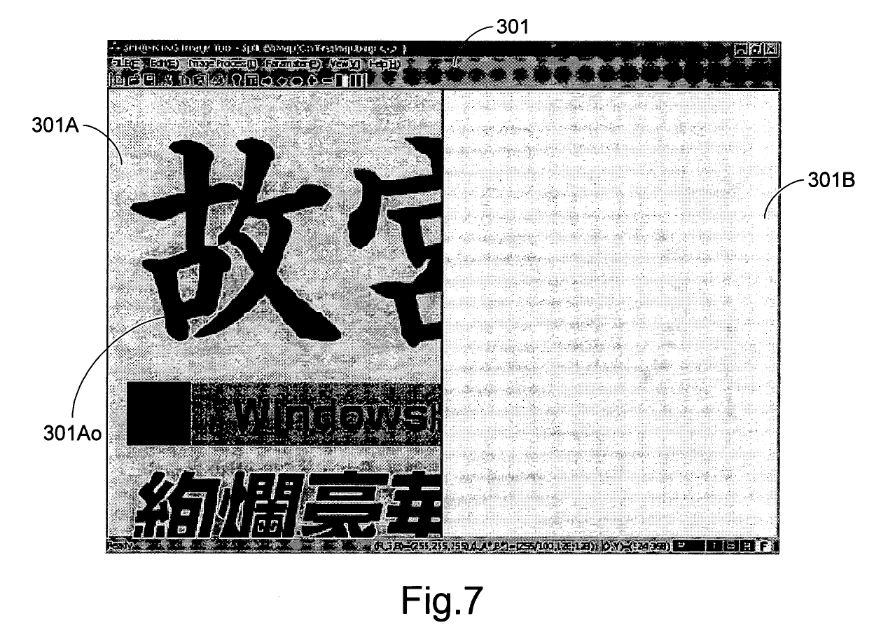

Referring to FIG. 7, parts of the original image 301Ao are displayed on the first display portion 301A by the display control module 601. After the original image file is opened, the image data Po1˜Po25 of the original image are stored in the first memory portion 400A of the first memory unit 400. In addition, by means of the display control module 601, the image data Po2˜Po16 of the original image to be displayed on the first display portion 301A of the display screen 301 are written into the first memory portion 500A of the second memory unit 500, and then the image data Po2˜Po16 of the original image are displayed on the first display portion 301A. For clearly viewing details of the original image, the whole original image needs not be displayed on the screen but only the original image 301Ao is displayed on the first display portion 301A.

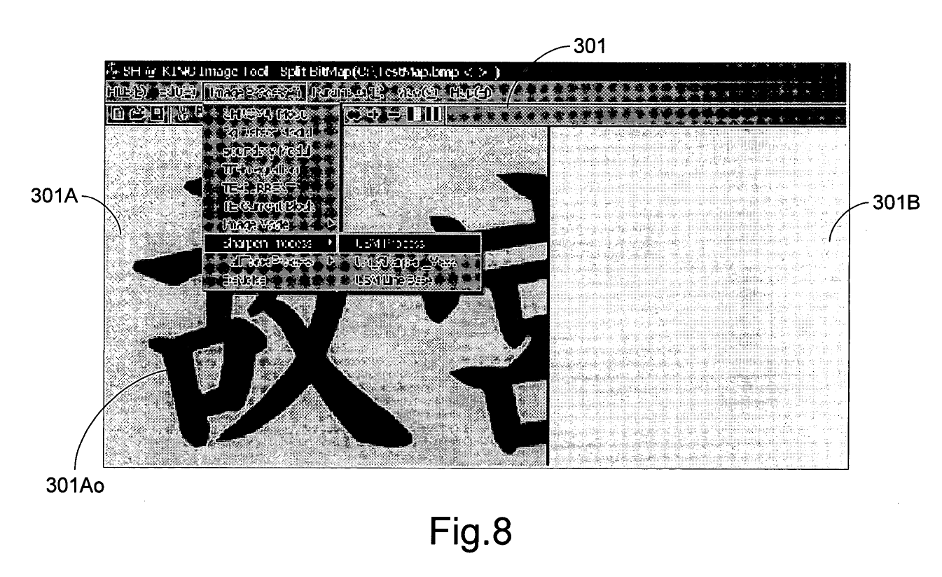

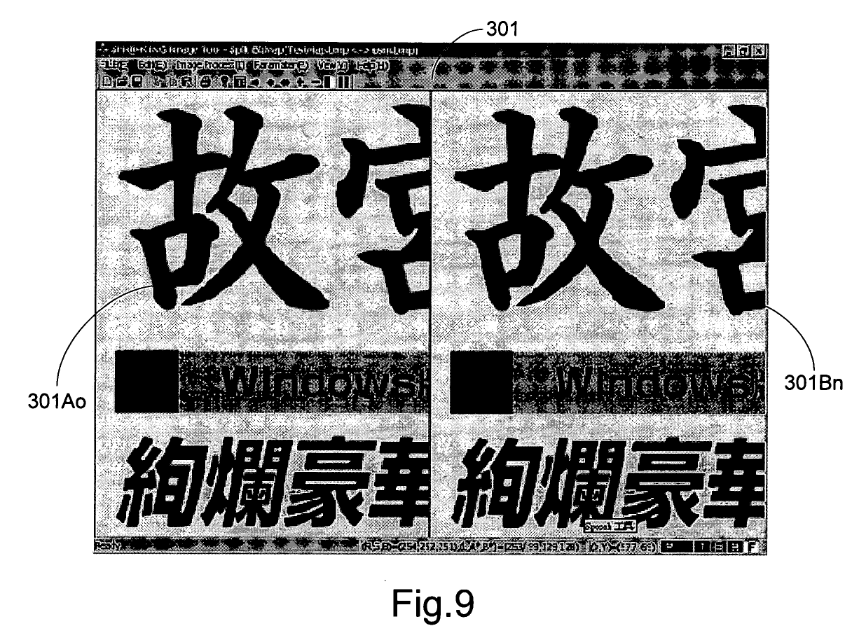

Referring to FIG. 8, an image processing command is then selected to process the original image 301Ao. In FIG. 9, the whole image data Pn1˜Pn25 of the processed image 301Bn are stored in the second memory portion 400B of the first memory unit 400. Then, by means of the display control module 601, the image data Pn2˜Pn16 of the processed image corresponding to the Po2˜Po16 of the original image to be displayed are written into the second memory portion 500B of the second memory unit 500, and then the image data Pn2˜Pn16 of the processed image are displayed on the second display portion 301B of the display screen 301. In other words, the contents of the original image 301Ao shown on the first display portion 301A are identical to those of the processed image 301Bn shown on the second display portion 301B. Accordingly, the user may clearly identify the contrast between the original image and the processed image.

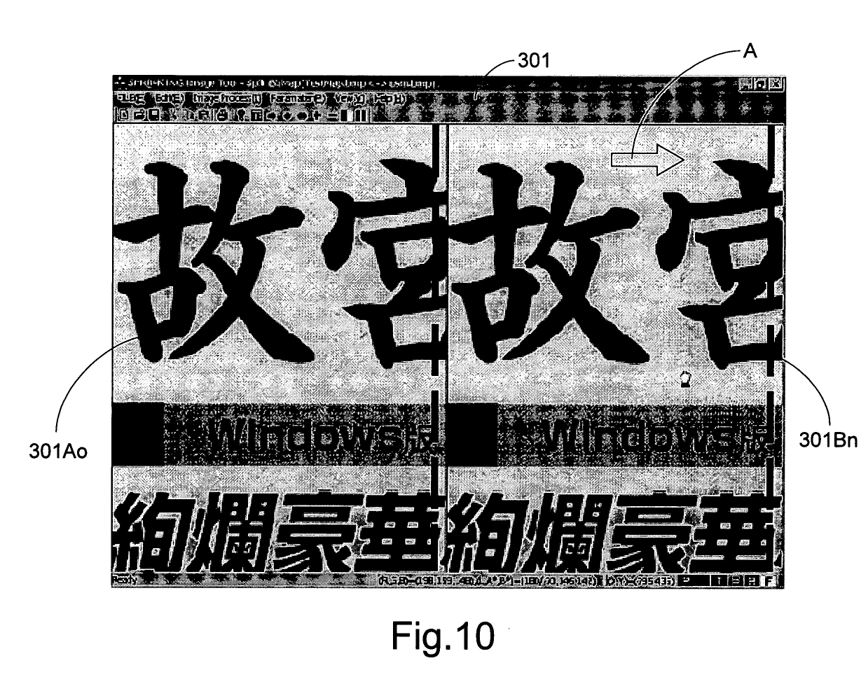

Referring to FIG. 10, when the user moves the cursor for example in the direction indicated by the arrow A, according to the changed coordinate positions on the display screen, the display control module 601 will write the corresponding image data Po2˜Po16 of the original image into the first memory portion 500A of the second memory unit 500 and write the corresponding image data Pn2˜Pn16 of the processed image into the second memory portion 500B of the second memory unit 500. Afterward, by the display control module 601, the image data Po2˜Po16 of the original image stored in the first memory portion 500A are displayed on the first display portion 301A, and the image data Pn2˜Pn16 of the processed image stored in the second memory portion 500B are displayed on the second display portion 301B. Meanwhile, the contents of the original image 301Ao shown on the first display portion 301A are identical to those of the processed image 301Bn shown on the second display portion 301B.

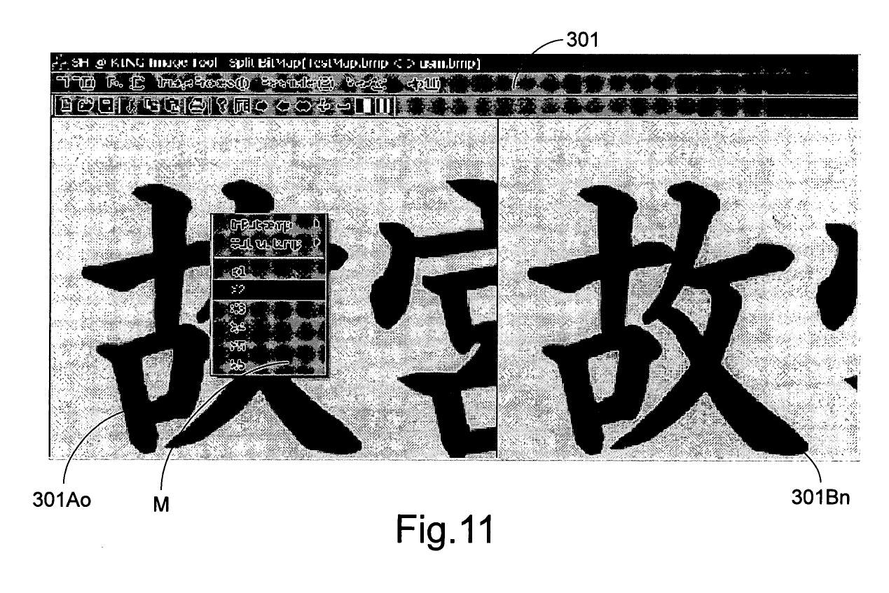

Referring to FIG. 11, for example, by depressing a button of the mouse, a magnification selective menu M is generated. After the desired magnification is selected, the original image shown on the first display portion and the processed image shown on the second display portion are simultaneously magnified. Consequently, the contents of the original image 301Ao shown on the first display portion 301A are identical to those of the processed image 301Bn shown on the second display portion 301B.

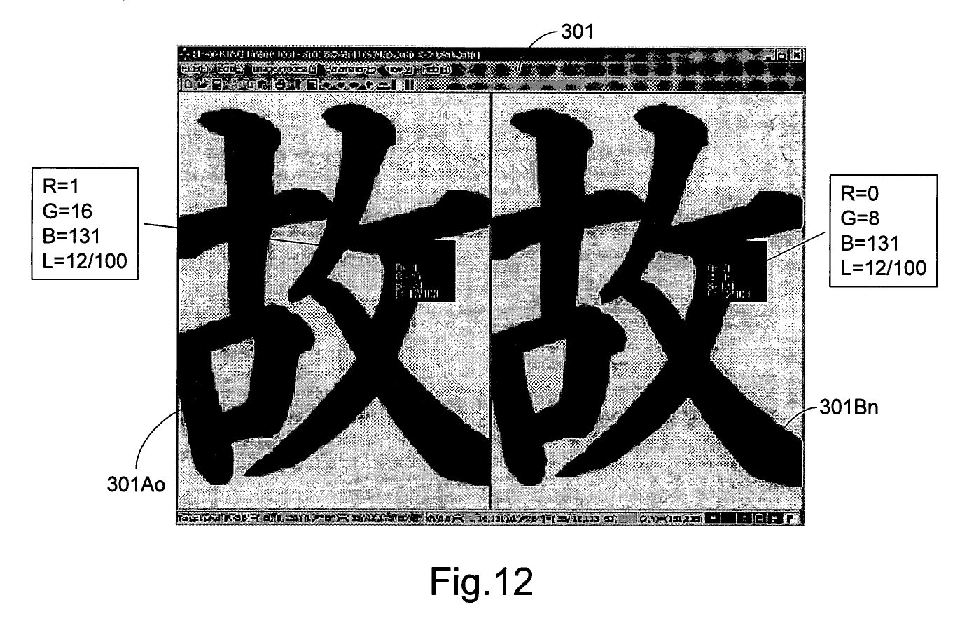

Furthermore, the image display system of the present invention can simultaneously display some pixel data of the original image 301Ao and the processed image 301Bn. As shown in FIG. 12, in a case that a specific pixel of the first display portion 301A or the second display portion 301B is selected by using the mouse, the display control module 601 will display the image data of the original image and the processed image on the first display portion 301A and the second display portion 301B, respectively, according to coordinates of the selected pixel. As also shown in FIG. 12, the image data of the selected pixel for the original image are (R=1, G=16, B=131, L=12/100), and the image data of the processed pixel are (R=0, G=8, B=131, L=12/100), where R, G and B indicates color values of red, green and blue colors, respectively, and L indicate brightness of the selected pixel. It is noted that, however, those skilled in the art will readily observe that numerous modifications and alterations of the pixel data to be displayed may be made while retaining the teachings of the invention. For example, any color-related parameters may be displayed on the display screen. Accordingly, the above disclosure should be limited only by the bounds of the following claims.

The image display system of the present invention is advantageous to those skilled in image processing technologies. For example, in order to exhibit and better understand a new product related to the image display system, the user could demonstrate relative operations to display the corresponding pixel data of the original image and the processed image.

In addition, if the user is intended to process the original image in several steps, the image processed by the present image display system at the first time may be stored as another original image, which will be further processed later as required.

From the above description, it is understood that the image display system of the present invention is capable of simultaneously displaying identical contents of the original image and the processed image on the display screen. In addition, in response to some specified commands, the original image and the processed image may be simultaneously magnified and moved and some specific pixel data are shown. Since the user no longer repeatedly opens/closes the original image file and the processed image file to view the difference between the original image and the processed image in real time, the image display system of the present invention is user-friendly and efficient.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image display system for simultaneously displaying an original image and a processed image of said original image on a display screen, said image display system comprising:
a monitor including said display screen, which is divided into a first display portion and a second display portion for displaying said original image and said processed image, respectively;
a first memory unit comprising a first memory portion and a second memory portion for storing therein all image data of said original image and said processed image, respectively;
a second memory unit comprising a first memory portion and a second memory portion for storing the image data of said original image to be displayed on said screen and the image data of said processed image to be displayed on said screen; and
a control unit including a display control module for controlling said original image displayed on said first display portion and said processed image on said second display portion according to execution of user's input commands.

2. The image display system according to claim 1 wherein said user's input commands are commands associated with an image magnifying operation and an image dragging operation.

3. The image display system according to claim 1 wherein the pixel brightness data of said original image and said processed image are displayed on said display screen in response to said user's input command.

4. The image display system according to claim 1 wherein said display control module is implemented by a software program.

5. An image display method for simultaneously displaying an original image and a processed image of said original image on a display screen, said image display method comprising:
dividing said display screen into a first display portion and a second display portion;
displaying part of said original image on said first display portion;
processing said original image, thereby obtaining said processed image;
displaying part of said processed image on said second display portion;
controlling said original image on said first display portion and said processed image on said second display portion according to execution of user's input commands.

6. The image display method according to claim 5 wherein said user's input commands are commands associated with an image magnifying operation and an image dragging operation.

7. The image display method according to claim 5 wherein the pixel brightness data of said original image and said processed image are displayed on said display screen in response to said user's input command.
